(19) United States
(12) Patent Application Publication
(10) Pub. No.: US 2009/0246997 A1
(43) Pub. Date: Oct. 1, 2009

(54) Modified Electrical Cable Connector Assembly

(76) Inventor: John Moller, Oakville (CA)

Correspondence Address: GOWAN INTELLECTUAL PROPERTY, 1075 NORTH SERVICE ROAD WEST, SUITE 203, OAKVILLE, ON, L6M-2G2, CA

(21) Appl. No.: 12/059,396

(22) Filed: Mar. 31, 2008

(51) Int. Cl. H01R 13/627

(52) U.S. Cl. 439/352

(57) ABSTRACT

An electrical connector comprises a plug and socket electrical connector which includes two contact inserts each of which is separately adapted to be snap-fitted and held within a backing shell. The contact inserts can be joined together to form an electrical connection, and are held together by a first locking mechanism such as a bayonet and socket arrangement. A second locking mechanism is provided comprising a mated pair of coupling rings which are adapted to surround the contact insert connection.

### FIELD OF THE INVENTION

This invention relates generally to electrical cable connectors, and more particularly, to a protective modification to be used in conjunction with a plug and socket, electrical cable connector.

### BACKGROUND OF THE INVENTION

Various wire connectors are known in the prior art. One particular type of connector utilizes a plug and socket approach for preparing the connector, and is described in, for example, U.S. Pat. No. 5,637,010. In these connectors, the various wires from an electrical cable are connected to either a male or female contact insert attachment. Once connected, the two contact inserts are “snapped” into two separate back shells, or housings, which hold the separate contact inserts. To establish an electrical connection, the male and female contact inserts are brought into operative engagement with one another. The components are typically held together by a bayonet and socket assembly. In this approach, a spring-loaded, or flexibly resilient, bayonet projection on one section of the connector is inserted into a corresponding recess in a socket section on the opposite connector, where it “clips” into position and locks the two components of the connector, together.

The dimensions of the inside and outside parts of the connector components are usually matched to one another, and the connectors can be used for various low voltage and higher voltage applications.

While this type of connection can be done for a single wire in a cable, more typically, the connector is a multi-pole connector having a plurality of wires within a cable, to be connected through the connector. Further, while the connector components can be used to connect one end of a cable to a second end of a corresponding cable, the connector can also be used to attach a cable directly to a socket assembly on an electrical device.

Often, the electrical connector arrangement further comprises a sealing means such that the electrical cable connection is protected from the weather once the bayonet and socket system has been fully engaged.

Commonly, the cable assemblies are pre-assembled so as to be easily connected and/or installed on the job site, as required.

For most routine operations, this arrangement provides a rapid and normally secure means for attachment of electrical cables, and these types of electrical cable connectors are widely used. For example, one supplier of these types of devices is Wieland Electric GmbH, of Germany.

However, occasionally, a more secure method of joining the electrical cable connector components is desired. For example, in an oil-sand production facility, the cable connectors must be more securely fastened to ensure that they do not become disconnected under the rough conditions and weather typically encountered. For example, cold weather can cause the bayonet section to become brittle and more easily broken, and the rough handling and other conditions can cause the connector components to be either exposed to the weather by failure of the sealing means, or in a worse case scenario, to become disconnected one from the other.

While stronger connectors of the bayonet and socket approach can be designed and built, this would require production and stocking of additional “stronger” devices having an increased cost. If the “weaker” devices were already stocked, it would be necessary to replace them and/or stock additional components by the cable manufacturer in order to prepare cables having improved resistance to this type of premature failure.

As such, it would be desirable to provide a more robust method of securing these types of plug and socket electrical cable connector assemblies, and in particular, a more robust method of securing those connectors which are held together by bayonet and socket assemblies.

Further, it would be desirable to provide a method for such providing improved securement capability in a manner which can be easily accomplished by a user, under harsh weather conditions;—preferably without having to remove the user's gloves or the like.

Still further, it would be desirable to provide an arrangement wherein the existing plug and socket electrical cable connectors could be modified to provide additional strength properties, and which could be easily added to the cable assembly during production.

### SUMMARY OF THE INVENTION

An exemplary implementation of an enhanced plug and socket electrical cable connector is provided herein wherein mated coupling rings are attached to each end of the cable connector assembly. These coupling rings are positioned on the ends of the mated connector components, but are sized so as to be connectable once the connector bayonet and socket arrangement has been engaged. The coupling rings are preferably threaded so as to allow an additional, and protective, locking means to be engaged once the cable connector components have connected.

The coupling rings are preferably mated, one to the other. Normally, coupling rings will also have a male and female engagement relationship, and this can be directly or indirectly related to the male/female engagement relationship of the electrical connector. For example, each male connector component might be associated with a male coupling ring, as will be seen hereinbelow.

Each portion of the coupling rings is sized so as to fit around at least part of the electrical connector assembly. At an end of the coupling ring, an aperture is provided through which the electrical cable can be fed. The aperture is sized so as to allow the cable to free pass through the coupling ring, but the aperture is small enough that the coupling ring preferably engages at least part of the back shell, or housing component. Prior to installation, the coupling ring can be free to move along the cable, or can be held adjacent to the connector component.

An exemplary implementation of the device includes a threaded coupling ring fitted to the cable connector at one end of a cable, and a second, correspondingly threaded coupling ring fitted to the matched connector at the end of a second cable, or on the contact insert and assembly, fitted directly to an electrical device. In this manner, the mated coupling rings can be connected one to the other after the electrical connector has been operatively connected.

In a further exemplary implementation, a plurality of cable connectors can be connected together using a multi-part connector assembly, such as a T-shaped apparatus, wherein each connector on the apparatus is fitted with a coupling ring which is adapted to be mated to a corresponding coupling ring on a connector affixed to the end of an electrical cable.

The advantages set out hereinabove, as well as other objects and goals inherent thereto, are at least partially or fully provided by the modified cable connector of the present invention, as set out herein below.

Accordingly, in one aspect, the present invention provides an enhanced electrical connector comprising:

at least two mated contact inserts connected to the ends of two electrical wires or cables and which form the ends of two connector assemblies, wherein said contact inserts are adapted to be connected together in order to form an electrical connection, and wherein said contact inserts have first locking elements adapted to hold the contact inserts in an operative connection; and

two mated coupling rings, separately attached to said contact inserts, which coupling rings can be brought into operative engagement as second locking elements, when said contact inserts have been connected together.

### BRIEF DESCRIPTION OF THE DRAWINGS

Embodiments of the invention will now be described by way of example only, in association with the accompanying drawings in which:

FIG. 1 is an exploded side view of a prior art plug and socket electrical connector;

FIG. 2 is an exploded side view of an enhanced plug and socket electrical connector of the present invention;

FIG. 3 is a perspective view of the two ends of the retainer nuts used as coupling rings, in the present embodiment;

FIG. 4A is a side view of the assembled components of the enhanced plug and socket electrical connector of the present invention, which are ready to be connected;

FIG. 4B is a side view of part of the connector assemblies from FIG. 4A;

FIG. 4C is a side view of the completely assembled connector of this embodiment of the present invention;

FIG. 5 is an exploded view of an embodiment of the enhanced connector of the present invention, wherein a cable is being attached to an electrical device; and

FIG. 6 is an exploded view of an embodiment of the enhanced connector of the present invention, which is being used in an multi-part connection apparatus.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements. Further, unless otherwise specifically noted, all of the features described herein may be combined with each other, in any combination.

It is expressly understood, however, that the drawings are for the purpose of illustration and description only and are not intended as a definition of the limits of the invention.

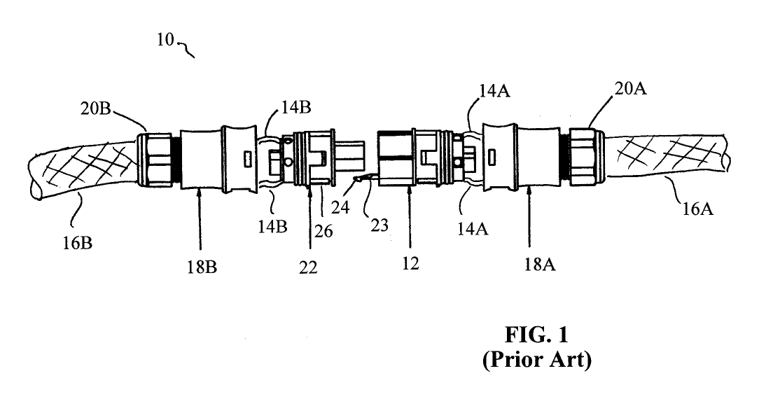

Referring to FIG. 1, a prior art plug and socket electrical cable connector apparatus 10 is shown having a female contact insert 12 to which the various wires 14A from electrical cable 16A have been attached. Female contact insert 12 is adapted to be snap-fitted into back shell 18A, which includes a threaded strain relief nut 20A which can be tightened so as to engage cable 16A.

Similarly, male contact insert 22 is connected to wires 14B which are contained within cable 16B, and is adapted to be snap-fitted within a second back shell 18B. Again, strain relief nut 20B is tightened so as to engage cable 16B.

A flexibly resilient plastic bayonet 23 having a barb 24 is provided on female contact insert 12, which is adapted to be fitted within a corresponding socket 26 on male contact insert 22. When male contact insert 22 is inserted into female contact insert 12, wires 14A and 14B are brought into operative connection. Simultaneously, bayonet 23 is inserted into recess 26 wherein barb 24 engages a stop located within recess 26. As bayonet 23 is inserted, it is deformed, but springs back into shape when fully inserted. Barb 24 is then engaged within recess 26, and holds male contact insert 22 in contact with female contact insert 12.

The components of prior art apparatus 10 are known within the industry. As will be known, while only one bayonet and barb have been shown, typically, a plurality of resilient bayonets with barbs can be used. Preferably, however, two bayonet with barbs, are used, and these are located opposite one another across the one connector component. The bayonet can be located on either the male or female contact insert.

The corresponding connector section on the mating connector, has a corresponding number of recesses for receiving the bayonets and barbs. For the locking process, the barbs 24 are preferably blocked against a radial deflection by a sleeve that surrounds the outside part coaxially. For disconnection of the electrical connector, the barbs can be pushed inwards to disengage the locking mechanism, and the connector components released from one another.

Under sufficient strain on the cable, however, barbs 24 can break, or can deform. Either situation can result in accidental disconnection of the cable wires, and it is this disadvantage of the prior art, that the present invention seeks to address.

The construction materials of the various components of the prior art device shown in FIG. 1, are all known within the industry, and are outside of the scope of the present invention. Further, providing a sealing means, such as an O-ring or the like on the contact inserts, and/or on the back shells, is also known within the industry, so as to prevent water, or the like, from reaching the exposed ends of wires 14. Again, though, the prior art sealing means and methods are outside of the scope of the present invention.

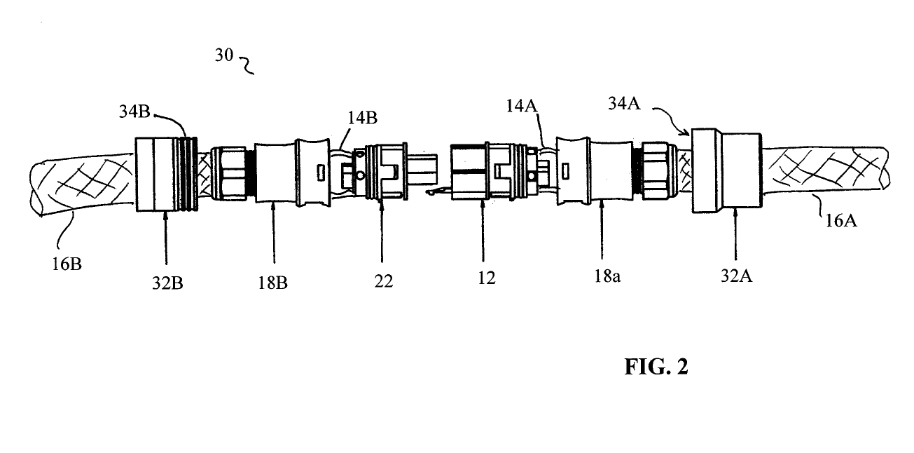

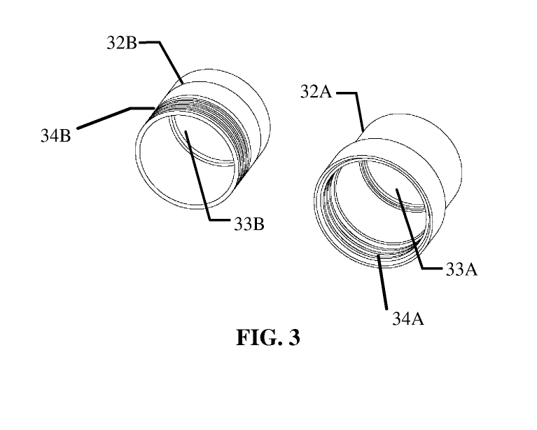

In FIG. 2, an exploded view of an enhanced electrical cable connector apparatus 30, in accordance with the present invention, is shown. Apparatus 30 includes the components described and shown in FIG. 1, but additionally includes a female retainer nut 32A located near back shell 18A, and a male retainer nut 32B located near back shell 18B. Matching threads 34B on the male retainer nut 32B, and 34A (FIG. 3) on female retainer nut 32A, are provided.

During assembly of the components, the ends of cables 16A and 16B are removed to expose the wires 14A and 14B contained therein. The ends are then passed through an aperture 33A or 33B (FIG. 3) in retainer nut 32A or 32B, and then through back shells 18A and 18B. The wires can then be connected to contact inserts 12 and 22.

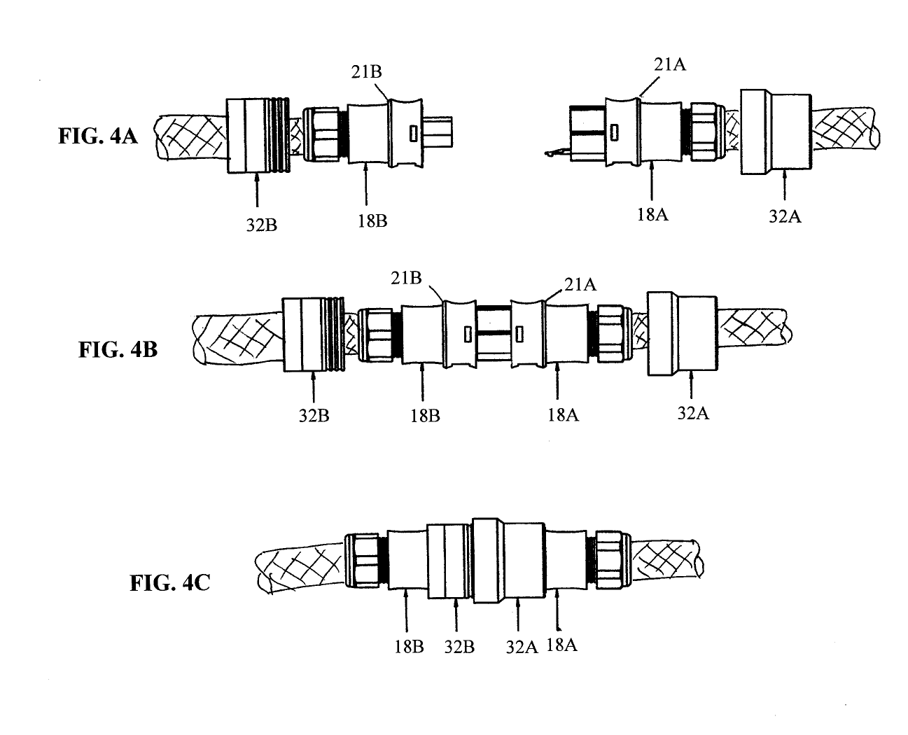

When this is complete, contact inserts 12 and 22 are snap fitted into back shells 18A and 18B, respectively. Once in place, strain relief nuts 20A and 20B are tightened to engage cables 16A and 16B. The cable is now ready to be shipped and/or used, and the assembled components can be seen in FIG. 4A.

In use, the male contact insert 22 of connector 30 is inserted into the female contact insert 12 so that an electrical connection is established between wires 14A and 14B. As a consequence of the insertion of male contact insert 22 into female contact insert 12, bayonets 23 is inserted and locked into recess 26. This can be seen in FIG. 4B. Male and female retainer nuts (32B and 32A), as coupling rings, can then be brought into contact with one another, and threaded together using the threads 34A and 34B. Retainer nuts 32A and 32B tighten against a shoulder 21A and 21B on back shells 18A and 18B respectively. The resultant, assembled enhanced electrical connector, as seen in FIG. 4C, is now complete, and the retainer nuts completely surround the area where the electrical connection is made, and are tightened against the back shoulders 21A and 21B of back shells 18A and 18B. This not only protects contact inserts 12 and 22, it also assists in maintaining the electrical contact between inserts 12 and 22 in conjunction with the bayonet 23 and recess 26 connection.

Retainer nuts 32A and 32B thus act as a simple, reliable coupling ring mechanisms to protect the entire connector 30 from damage, and act to prevent the premature or accidental disconnection of the electrical cables. Further, retainer nuts 32A and 32B can be sized so as to be easily threaded together even by an operator wearing gloves, or the like.

Retainer nuts 32A and 32B can be made from any suitable material including metal or plastics, for example. However, preferred materials include impact resistant polymers including polyethylene, polypropylene, impact modified styrene or ABS, or the like. Again, for cold environments, plastic components are preferred to avoid contact by the user with cold metal.

Retainer nuts 32A and 32B, when assembled, are not typically used for protection of the connector from the weather and/or water, since this function is already provided within connector 30. However, retainer nuts 32A and 32B can be modified to provide this function, if required.

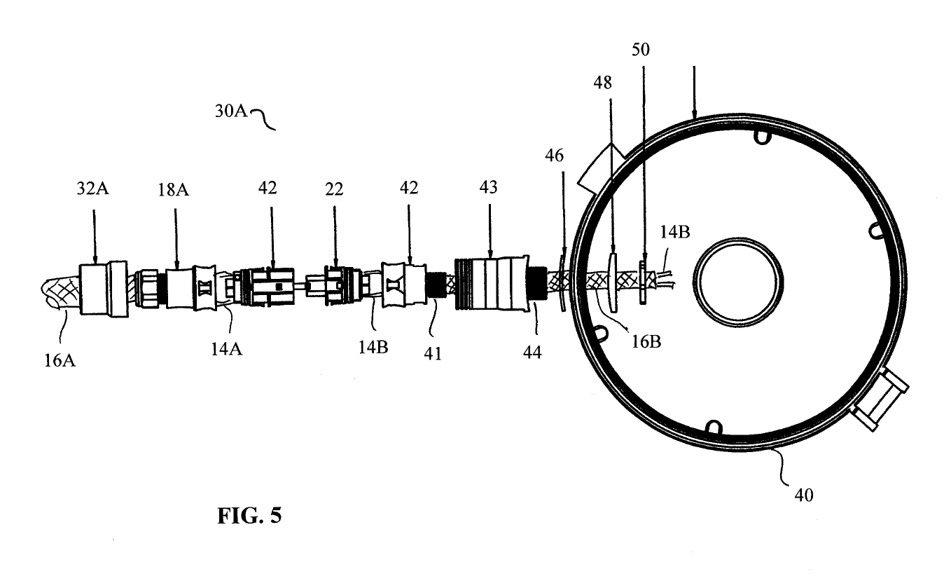

In FIG. 5, an exploded side view is shown of a connector 30A which is adapted to be fitted directly to an electrical device. In this case, the electrical device is a light assembly 40, and connector 30A is a modified connector; one end of which has been modified so as to be adapted to be attached to light assembly 40. As a result, Wires 14B extend from cable 16B within the light assembly 40, where they can be connected to the electrical connections for light assembly 40. Back shell 18B has been replaced with a modified, threaded back shell 42 which does not include a strain relief nut 20B, but has modified thread 41 adapted to be threaded into the inside of modified retainer nut 43. Modified retainer nut 43 also includes an additional threaded section 44, which section 44 is inserted through a rubber gasket 46, a suitably sized opening in light assembly 40, a equalization plate 48. A lock nut 50 is threaded onto threaded section 44 in order to hold retainer nut 43, back shell 42 and contact insert 22, on to light assembly 40.

In use, contact inserts 12 and 22 are snapped into back shells 18A and 42, respectively. Contact insert 12 is inserted into contact insert 22, as previously described, and the bayonet and recess arrangement provides a locked electrical connection. Retainer nut 32A is then threaded onto the end of modified retainer nut 43 to provide an enhanced electrical connector.

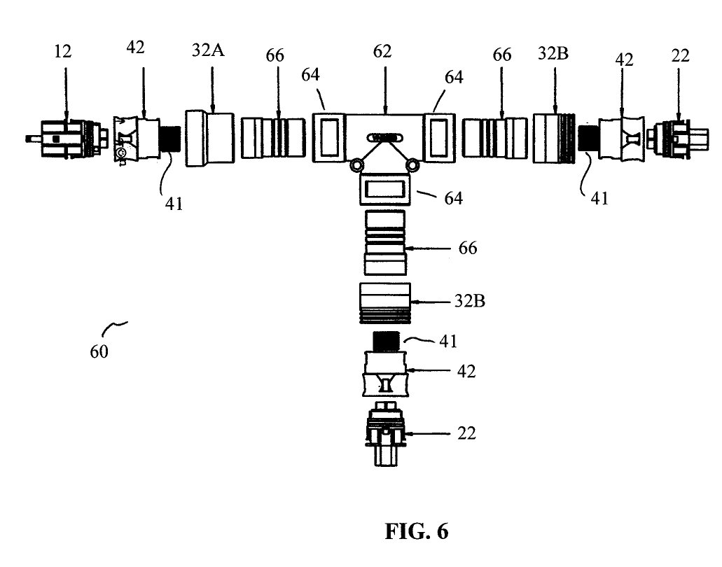

In FIG. 6, an exploded side view of a multi-part cable connector 60 having a central connector apparatus 62 is shown having a T-shape, and thus having three separate legs 64. The cables and wires have been omitted for this embodiment.

Connected to each leg 64 is an adaptor 66 which is inserted into leg 64 and held in place by a clip lock, or some other device. Adapter 66 has an internal, female thread section (not shown) which is adapted to receive the male threaded section 41 from modified back shell 42. Male and female contact inserts (12, 22) are inserted into back shells 42. Male and female retainer rings (32A and 32B) are provided at the end of each back shell 42, and are adapted to be connected to the corresponding retainer rings from the individual cables and connectors (not shown) that are to be attached to connector 60.

In use, the ends of three cables can be attached to connector 60, in the manner previously described.

Thus, it is apparent that there has been provided, in accordance with the present invention, a modified and enhanced electrical cable connector, which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively.

Also, while this discussion has addressed prior art known to the inventor, it is not an admission that all art discussed is citable against the present application.

1. An enhanced electrical connector comprising:
at least two mated contact inserts connected to the ends of two electrical wires or cables and which form the ends of two connector assemblies, wherein said contact inserts are adapted to be connected together in order to form an electrical connection, and wherein said contact inserts have first locking elements adapted to hold the contact inserts in an operative connection; and
two mated coupling rings, separately attached to said contact inserts, which coupling rings can be brought into operative engagement as second locking elements, when said contact inserts have been connected together using said first locking elements.

2. An enhanced electrical connector as claimed in claim 1 wherein said enhanced electrical connector is a plug and socket device wherein said contact inserts are adapted to be snap fitted within a back shell or housing.

3. An enhanced electrical connector as claimed in claim 1 wherein said coupling rings are threaded so as to allow a threaded connection between the coupling rings.

4. An enhanced electrical connector as claimed in claim 1 wherein said first locking elements are a bayonet and socket locking arrangement.

5. An enhanced electrical connector as claimed in claim 1 wherein said contact inserts have a male and female mating relationship, and said coupling rings have a corresponding male and female mating relationship.

6. An enhanced electrical connector as claimed in claim 2 wherein each of said back shells includes a shoulder section, and said coupling rings are sized so as to engage said shoulder section.

7. An enhanced electrical connector as claimed in claim 1 wherein at least one of said contact inserts is also directly connected to an electrical device.

8. An enhanced electrical connector as claimed in claim 1 wherein a plurality of cable connectors are provided on a multi-part connector assembly.

9. An enhanced electrical connector as claimed in claim 8 wherein said multi-part connector assembly is a T-shaped apparatus.

10. An enhanced electrical connector as claimed in claim 1 wherein said connector is a multi-pole cable connector.
